(19) United States
(12) Patent Application Publication
(10) Pub. No.: US 2011/0103889 A1
(43) Pub. Date: May 5, 2011

(54) SOIL STABILIZATION BLEND AND METHOD OF SOIL STABILIZATION

(76) Inventors: Ward S. Blakefield, Maysville, KY (US); James Michael Hays, Arcadia, LA (US)

(21) Appl. No.: 12/938,862

(22) Filed: Nov. 3, 2010

Related U.S. Application Data
(60) Provisional application No. 61/257,895, filed on Nov. 4, 2009.

(51) Int. Cl. E01C 7/32; E02D 3/00; C04B 28/10

(52) U.S. Cl. 404/75; 405/302.4; 106/793; 106/718

(57) ABSTRACT

An improved blend added to soil for soil strengthening and stabilization comprising the combination of 15 to 60 percent by weight of a lime component, such as quicklime, hydrated lime and/or a lime by-product, such as lime kiln dust, with a balance or remainder of cement. The blending of the materials has a synergistic effect, such that the resulting product exceeds the soil strengthening and soil stabilization capabilities of the individual components. The synergistic effect further extends to the hardening and curing characteristics of the blend, in that the blend has a very short hardening time compared with its component parts. The blend physically and chemically modifies the soil to which it is applied to accomplish the soil strengthening and stabilization impacts, and is applicable to a wide range of soil types and conditions. The improved hardening and curing characteristics of the blend results from the presence of certain chemical constituents of the lime kiln dust and the impact of these constituents on the cement component of the blend. A method to produce and apply the blend is also claimed.

### CROSS REFERENCE

This application claims the benefit of U.S. Provisional Application No. 61/257,895, filed on Nov. 4, 2009, and entitled SOIL STABILIZATION PRODUCT, the entirety of which is incorporated herein by reference.

### BACKGROUND OF THE INVENTION

The present invention relates generally to soil stabilization in construction projects. Currently there is an issue with respect to creating access roads to the site of an oil or gas well when the soil that leads to the oil or gas well contains clay. Typically in soil that does not contain clay, cement is placed on the soil to create a roadway for heavy equipment so that heavy equipment can have access to a well site. However, if there is clay in the soil, this creates a problem whereby the cement cannot obtain sufficient strength due to poor pulverization and compaction of the soil. This is commonly solved by adding additional cement to the failed subgrade to achieve strength requirements. By using this method, additional time and money is wasted. This method can require over 72 hours before vehicles and equipment can have access to the well site. As an alternative, the treatment of the clay with lime takes several days to one week. After the clay has been treated with lime then cement is used to create the roadway and access to the well.

Heretofore, available products that provide soil strengthening and stabilization for construction projects have suffered from one or more disadvantages. Products that are designed to harden and cure quickly, to meet short construction schedules and tight time requirements do not provide sufficient soil strength improvement or soil stabilization. Products that provide sufficient soil stabilization and strength improvement for construction projects cure and harden too slowly and/or require the addition of other products to finalize the construction project. Use of these products is not feasible for construction projects with short time schedules.

Attempts have been made to produce products for construction projects that provide soil strengthening and stabilization and that will harden and cure in a relatively short period of time. Heretofore, such attempts have been unsuccessful. Attempts to add soil strengthening capabilities to fast-curing products have not significantly improved the soil strengthening characteristics of these products and in some instances have negatively impacted the fast-curing aspect of the product. (See, e.g., Adaska and Taubert, 2008, p. 1, citing studies that found that blending cement kiln dust with portland cement “reduced workability, setting times and strength”).

### DESCRIPTION OF THE RELATED ART

A quick setting cement with lime and aluminates is disclosed in U.S. Pat. No. 6,602,343, which issued Aug. 5, 2003 to Costa and Barcella. The described blended product disclosed in the patent has a very short hardening time but unlike the present invention, does not address the issue of soil strengthening and stabilization through chemical and physical modification of a variety of soils.

Similarly, U.S. Pat. No. 3,856,540 issued to Mizunuma and Yoshida on Dec. 24, 1974, discloses a cement additive that improves the hardening and strength of cement, but does not address soil strengthening and stabilization issues. These subjects are also not addressed in U.S. Pat. No. 3,628,973, issued on Dec. 21, 1971 to Greening, et al. disclosing a modified portland cement and process, and U.S. Pat. No. 7,169,255, issued on Jan. 30, 2007 to Garcia Luna et al., disclosing anhydrite cement compositions and procedures for manufacture.

The related art disclosing blended products that do include the addition of materials to strengthen or stabilize soils in construction applications, such as U.S. Pat. No. 7,353,870, issued on Apr. 8, 2008 to Roddy, et al., disclosing methods of using settable compositions comprising cement kiln dust and additive(s), do not focus on improving the curing and hardening time of the product such that the product can be applied to meet a construction schedule that is time-limited.

U.S. Pat. No. 6,695,545, issued on Feb. 24, 2004 to Boston, Discloses a soil stabilization composition that improves the soil stabilization characteristics of cement composition, but requires a relatively long (72 hours or more) curing period, significantly longer than the present invention, U.S. Pat. No. 6,076,997, issued to First et al. on Jun. 20, 2000, disclosing a deep mix soil stabilization method likewise discloses a drying and curing period for its product, as well as a requirement for deep mixing with soils that is not required for the present invention. U.S. Pat. No. 6,402,833, issued on Jun. 11, 2002 to O'Hearn et al., disclosing a binder for mine tailings although including lime kiln dust as an optional or alternative component of its product blend, also requires significant curing time, making it unsuitable for the short construction schedules addressed by the present invention.

### SUMMARY OF THE INVENTION

The present invention provides a method for construction of an access road to the site of an oil or gas well including: providing a well site; determining a path for the well site having unstable soil; providing a soil stabilization product having a blend of lime kiln dust with cement; applying the soil stabilization product to the path; and curing and hardening of the soil stabilization product whereby an access road to the well is created. The stabilization process resulting in sufficient soil strength gain to allow for further site construction and use can be completed within 24-48 hours.

The present invention also provides a method of preparing a soil stabilization product including: obtaining a quantity of cement; obtaining a quantity of lime kiln dust; and blending the quantity of cement with the quantity of lime kiln dust in a silo. The blending can also take place in another type of structure including other storage structures, or in a truck or other form of transport.

The present invention achieves soil strengthening and stabilization through physical and chemical modification of the soil to which it is applied during a construction project. This invention, with the synergistic combination of cement and lime compounds provides the necessary chemical components for stabilization of fine grain soils with a cement product, meeting criteria for strength gain and short cure times.

The use of cement products on these fined grained clay soils is not an accepted practice by those in the industry and often results in insufficient pulverization of the soils, leading to poor compaction and reduced strength.

The blend of the cement/lime mixtures provides, in synergistic combination, the cement necessary to achieve early strength, and rapid curing and the lime component necessary to break down the clay minerals so that improved compaction and strength can be achieved. This combination results in significantly increased pulverization of the clay particles in the soil, leading to improved workability by the contractor, greater compaction, and increased early strength, when compared to the use of cement alone in this application. The blended product of the current invention is stronger than cement alone. The strength continues for weeks thereafter. The blend pulverizes larger clay particles, allowing greater compaction and strength. Cement alone cannot do this.

The soil stabilization blend and method of soil stabilization of the present invention is provided to improve soil strength while concurrently providing rapid hardening and curing of a soil stabilization blend in construction projects. 15% to 60% by weight of a lime component, such as quicklime, hydrated lime and/or lime by-products, such as lime kiln dust, is blended with a balance or remainder consisting of cement. The lime component can be a mix of lime products, and may, for example, include quicklime and lime kiln dust in combination to increase the available CaO of the lime kiln dust prior to blending the lime kiln dust with the cement. The blend is applied to soil to be stabilized and then cured and hardened.

The lime component may be a high quality lime kiln dust that meets the following specifications: available CaO (greater than)>25%; SiO₂=−4-10%; A_{l2O3}=1-8%; MgO (less than)<4%; and Gradation=50%<200 Mesh. The cement component in the blend may be any number of cement types, such as portland cement, portland cement clinker, weathered portland cement clinker, weathered cement clinker, or a blend of these and other types of cements.

The soil to which the blend is applied may be within AASHTO Group Classification A-1, A-2 or A-3 or A-4 through A-8, preferably A4 through A8. The AASHTO Soil Classification System was developed by the American Association of State Highway and Transportation Officials and is used as a guide for the classification of soils and soil-aggregate mixtures for highway construction purposes. These soil classifications may be found online at “http:/en.wikipedia.org/wiki/AASHTO_Soil_Classification_System”. It is an accepted practice that cement products are best suited for stabilization of soils with a plasticity index typically less than 12. These soils, typically classified as AASHTO A1, A2, and A3 soils are coarse grained soils with a maximum of 35% passing the 200 mesh screen (0.75 mm). In the Unified Soil Classification System, these same coarse grained soils are grouped into major divisions of gravels and sand with group symbols of GW, GP, GM, GC, SW, SP, SM, and SC. Finely grains soils, defined in the AASHTO Soil Classification Systems, as having >35% passing the 200 mesh (0.075 mm), are understood in the industry as best suited for stabilization with lime products. These soils would fall into the general classifications of A4, A5, A6, A7, A7-5, A7-6, or in the Unified Soil Classification System as ML, CL, MH, CH, OH.

The blend may be applied over the soil surface to be stabilized or combined therewith the result of obtaining a California bearing ratio (CBR) of the soil which is greater than 50 within 24-48 hours after combining or a CBR of the soil which is greater than 100 within 24-48 hours after combining.

The blend and method of the present invention is effective in the short time schedule construction of roadways in the field for access to sites for oil and gas wells. The blend may be applied to a soil road. The blend may then be cured and hardened.

The blend of the present invention may be efficiently and effectively blended in a silo, or other structure or in a truck or other means of transport.

### DESCRIPTION OF PREFERRED EMBODIMENTS

The current invention solves the problem of sufficient rapid curing while still providing sufficient strength by a combination of lime kiln dust with cement. The combination of these materials allows for the access road to the site of the well to be completed within 24 hours. When completed within 24 hours, it has the same strength and hardness as it would have, had the lime been added to treat the road separately for several days to one week. After 24 hours the strength is significant enough for heavy machinery and industrial equipment to go across it. It would also pass the current known in the art jackknife penetration test for strength purposes. The synergistic combination allows for a roadway to be paved within 24-48 hours to a well site in which the soil has a clay component, the access road having sufficient strength to support industrial machinery and other equipment necessary at the well site. Additionally, it will pass the current testing standards for well site access roads. Those tests are known in the art.

The use of lime and cement stabilization to improve soil strength and soil properties is wide spread across the United States, and the reagent/soil chemistries are well understood.

The present invention is a blend of 15% to 60% by weight of a lime component such as quicklime, hydrated lime or lime by-product such as lime kiln dust, and a balance or remainder of cement and the advantage is that the components of the blend combine synergistically to produce both of the following results:
1. Soil stabilization and strengthening for construction projects through physical and chemical reactions that occur when the present invention is applied to soils;
2. Rapid curing and hardening such that the product can be used for construction projects that require that the project surface is cured and hardened in a short period of time, generally in 24 hours or less.

The production of cement is an old art. With respect to the present invention, the term is used in the context of construction projects, wherein it can be defined as a building material made by grinding calcined calcium carbonate and fine-grained soil material, and in some instances one or more of a wide range of additional materials, to a fine powder, which can be mixed with water and poured to set as a solid mass or used as an ingredient in making mortar or concrete. The present invention can utilize a wide range of cements, including but not limited to portland cement (which adds a small amount of gypsum to limestone and a clay or shale in the grinding process), the variety of cement commonly used in construction projects.

Lime kiln dust is a by-product generated during lime production, consisting of a fine powder collected by the dust control systems of lime kilns. The lime kiln dust component of the present invention adds available calcium oxide and pozzolanic to the cement which acts to reduce the hardening and curing time of the product, enabling its use in various construction projects requiring that the applied product cure sufficiently within 24-48 hours. Without the cement component of the present invention, the lime kiln dust requires a significantly longer hardening and curing period, while without the lime kiln dust component, the cement component of the present invention will not stabilize a wide range of soils through physical and chemical modifications. The components of the present invention act synergistically to produce a product that is far superior to the component parts for construction projects limited to a short duration and involving a wide range of soils.

The effects of the lime kiln dust (“LKD”) in the present invention arise from, and relate to, the unique chemical composition of the LKD. LKD is variable in composition and for the present invention, a high-quality LKD should be used to fully obtain the advantages provided by the product. The following specification applies to such high-quality LKD.

| | |
|---|---|
| Available CaO | >25% |
| SiO₂ (POZZOLAN) | −4-10% |
| A_{12O3} (POZZOLAN) | 3-8% |
| MgO | <4% |
| Gradation | 50% <200 Mesh |

As shown on the above table, LKD contains pozzolans, siliceous or aluminous material that when combined with calcium hydroxide forms cementious compounds. As a result of the presence of this material, in the present invention, the LKD acts to improve the hardening and curing characteristics of the cement component of the blend. This allows the present invention to be used in construction projects that require a product with curing times of less than 24-48 hours. The optimum percentage of LKD or lime in the blend should be high enough to achieve as much pulverization as possible, while still achieving short-term strength from the cement in the blend. The percentage will vary within the suggested range above depending on the specific conditions at a particular site, but the percentage of LKD or lime will be significantly higher than would be used to simply add a small amount of LKD to cement to help in curing.

The LKD also plays a critical role in the soil strengthening and stabilization characteristics of the present invention. Principally, the LKD causes pulverization of large particles resulting in greater compaction and therefore greater strength. The LKD also modifies the soil to which the present invention is applied in a number of additional ways, including: moisture reduction (drying): plasticity reduction; reduction or elimination of swell potential; and improved stability.

The available Calcium Oxide (CaO) in the LKD also reacts chemically with soil at the molecular level to stabilize the soil. As has been well-documented in the literature, (See e.g. Little, 1995, pp. 37-40) the calcium atoms from available CaO in the LKD replace the sodium and hydrogen atoms in the soil, resulting in a significantly more stable soil. This chemical reaction results in an increase in the CBR of the stabilized material. In some instances, the LKD used in the present invention may require additional available CaO to full achieve the improvements inherent in the product. In such instances, a small percentage of quicklime can be added to the LKD prior to blending with the cement, to provide the additional available CaO.

In a preferred embodiment it is believed that the more homogenous the blend, the better the effectiveness. Thorough mixing before transport and maintaining the blend in as homogenous a form as possible may be the best way to maximize its effectiveness.

The present invention synergistically combines the LKD with the cement component of the product to create superior curing and hardening and soil strengthening and stabilization.

The present invention is of particular utility when utilized in construction projects that require a fully hardened and stabilized surface within a short period of time following application of the product to the soil. For example, roads constructed for access to oil and gas wells are typically completed within a two day period. In a short construction schedule of this type, it is essential that the product used to stabilize the soil achieves sufficient strength so that the soil is able to support heavy vehicles including trucks and well drilling rigs within 24-48 hours of application to the soil. This is just one example of the type of project that can benefit from the present invention; many other types of projects are constrained by short construction schedules and would therefore benefit from the use of the product. A further advantage of the present invention in this context is that the improvements apply to a wide range of soils, eliminating the need to test or categorize the soil prior to application of the product thereby avoiding the project delays associated with such testing.

We claim:

1. A soil stabilization blend comprising:
15 to 60 percent by weight of a lime component selected from the group consisting of quicklime, hydrated lime and lime by-products, including lime kiln dust, and a remainder of cement.

2. The soil stabilization blend of claim 1 wherein said lime component includes lime kiln dust as a high quality lime kiln dust that meets the following specification: available CaO>25%; SiO₂=−4-10%; A_{l2O3}=1-8%; MgO<4%; Gradation=50%<200 Mesh.

3. The soil stabilization blend of claim 1 wherein said lime component includes quicklime and lime kiln dust to increase the available CaO of the lime kiln dust prior to blending the lime kiln dust with the cement.

4. The soil stabilization blend of claim 1 wherein the cement in the blend is portland cement.

5. The soil stabilization blend of claim 1 wherein the cement in the blend is portland cement clinker.

6. The soil stabilization blend of claim 1 wherein the cement in the blend is weathered portland cement clinker.

7. The soil stabilization blend of claim 1 wherein the cement in the blend is weathered cement clinker.

8. The soil stabilization blend of claim 1 wherein the cement in the blend is a blend of different types of cement.

9. The soil stabilization blend of claim 1 wherein the blend is combined with soil to be stabilized that is within AASHTO Group Classification A-4 through A-8.

10. The soil stabilization of claim 1 wherein the blend is combined with soil to be stabilized and the CBR of the soil after combination with the blend is greater than 50 within 24 hours after the addition of the blend to the soil.

11. The soil stabilization of claim 1 wherein the blend is combined with soil to be stabilized and the CBR of the soil after combination with the blend is greater than 100 within 24-48 hours after the addition of the blend to the soil.

12. The soil stabilization blend of claim 1 wherein the blend is applied to a soil road.

13. A method of soil stabilization to improve soil strength while concurrently providing rapid hardening and curing of a soil stabilization blend in construction projects, comprising:
blending 15 to 60 percent by weight of a lime component selected from the group consisting of quicklime, hydrated lime and lime by-products, including lime kiln dust, with a remainder of cement;
applying said blend to soil to be stabilized; and
curing and hardening said applied blend.

14. The method of claim 13 wherein said lime component includes a high quality lime kiln dust that meets the following specification: available CaO>25%; SiO₂=4-10%; A_{l2O3}=1-8%; MgO<4%; Gradation=50%<200 Mesh.

15. The method of claim 13 wherein the cement in the blend is portland cement.

16. The method of claim 13 wherein the cement in the blend is portland cement clinker.

17. The method of claim 13 wherein the cement in the blend is weathered portland cement clinker.

18. The method of claim 13 wherein the cement in the blend is weathered cement clinker.

19. The method of claim 13 wherein the cement in the blend is a blend of different types of cement.

20. The method of claim 13 wherein the soil to which the blend is applied is within AASHTO Group Classification A-4 through A-8.

21. The method of claim 13 wherein the step of applying includes combining the blend with the soil to be stabilized and thereby obtaining a CBR of the soil greater than 50 within 24 hours after combining.

22. The method of claim 13 wherein the step of applying includes combining the blend with the soil to be stabilized and thereby obtaining a CBR of the soil greater than 100 within 24-48 hours after combining.

23. The method of claim 13 wherein the blend is applied to a soil road and then curing and hardening the blend.

24. The method of claim 13 wherein the blend is blended in a silo.

25. A method for construction of an access road to the site of an oil or gas well comprising:
(a) providing a well site;
(b) determining a path for the well site having unstable soil;
(c) providing a soil stabilization product having a blend of lime kiln dust with cement;
(d) applying the soil stabilization product to the path; and
(e) curing and hardening of the soil stabilization product whereby an access road to the well is created.

26. A method as recited in claim 25 wherein the curing and hardening is completed within 24 hours.

27. A method of preparing a soil stabilization product comprising:
(a) obtaining a quantity of cement;
(b) obtaining a quantity of lime kiln dust; and
(c) blending the quantity of cement with the quantity of lime kiln dust in a vessel.
